(19) United States
(12) Patent Application Publication
(10) Pub. No.: US 2026/0309096 A1
(43) Pub. Date: Oct. 8, 2026

(54) CONTROL DEVICE FOR GAS TURBINE, GAS TURBINE FACILITY, CONTROL METHOD FOR GAS TURBINE, AND CONTROL PROGRAM FOR GAS TURBINE

(71) Applicant: MITSUBISHI HEAVY INDUSTRIES, LTD., Tokyo (JP)

(72) Inventors: Kengo OKAMOTO, Tokyo (JP); Teruhiro MATSUMOTO, Tokyo (JP); Kuniharu FUJIBAYASHI, Tokyo (JP); Yasuhiro NIINA, Tokyo (JP); Ryusuke KUBOYAMA, Tokyo (JP)

(21) Appl. No.: 18/875,366

(22) PCT Filed: Jun. 20, 2023
(86) PCT No.: PCT/JP2023/022769

§ 371 Date: Dec. 16, 2024

(30) Foreign Application Priority Data
Jul. 8, 2022 (JP) 2022-110230

(51) Int. Cl. F02C 9/28; F02C 7/268

(52) U.S. Cl. CPC F02C 9/28; F02C 7/268; F05D 2260/85; F05D 2270/04

(57) ABSTRACT

A control device for a gas turbine is a control device for controlling operation of the gas turbine, including: a fuel command value calculation unit for calculating a fuel command value to be provided to the gas turbine; and an acceleration rate setting unit for setting an acceleration rate set value of a rotor of the gas turbine. The acceleration rate setting unit is configured to increase the acceleration rate set value, during startup of the gas turbine and after a switching timing at which the fuel command value calculated by the fuel command value calculation unit switches from constant to continuous increase.

### TECHNICAL FIELD

The present disclosure relates to a control device for a gas turbine, a gas turbine facility, a control method for the gas turbine, and a control program for the gas turbine.

This application claims the priority of Japanese Patent Application No. 2022-110230 filed on Jul. 8, 2022, the content of which is incorporated herein by reference.

### BACKGROUND

At startup of a gas turbine, after ignition of fuel in a combustor, a rotor is accelerated until a rotor rotation speed reaches a predetermined rotation speed (for example, a rated rotation speed).

For example, Patent Document 1 describes that a rotor rotation speed is increased at a predetermined rotational acceleration (acceleration rate) determined on the basis of a safety index indicating a relationship between damage to a gas turbine component and a rotational acceleration of a rotor, after fuel ignition, at startup of a gas turbine.

### CITATION LIST

### Patent Literature

Patent Document 1: JP2013-221423A

### SUMMARY

### Technical Problem

Meanwhile, in order to shorten a startup time of a gas turbine, it is conceivable to set an acceleration rate (rotational acceleration) of a rotor during startup of the gas turbine to a value greater than that in the past. However, if an output of a start-up motor, etc., is more increased than in the past to increase the acceleration rate of the rotor than in the past during a period immediately after ignition of the gas turbine, in which the amount of fuel supply is relatively small, the rotation speed of the rotor increases more than in the past and the amount of air suction in a compressor increases, thereby decreasing the fuel-air ratio (F/A ratio) and increasing the possibility of misfire in the combustor.

In view of the above, an object of at least one embodiment of the present invention is to provide a control device for a gas turbine, a gas turbine facility, a control method for the gas turbine, and a control program for the gas turbine, which are capable of rapidly starting the gas turbine while suppressing misfire.

### Solution to Problem

A control device for a gas turbine according to at least one embodiment of the present invention is a control device for controlling operation of a gas turbine, including:

a fuel command value calculation unit for calculating a fuel command value to be provided to the gas turbine; and an acceleration rate setting unit for setting an acceleration rate set value of a rotor of the gas turbine. The acceleration rate setting unit is configured to increase the acceleration rate set value, during startup of the gas turbine and after a switching timing at which the fuel command value calculated by the fuel command value calculation unit switches from constant to continuous increase.

Further, a control device for a gas turbine according to at least one embodiment of the present invention is a control device for controlling operation of a gas turbine, including: a fuel command value calculation unit for calculating a fuel command value to be provided to the gas turbine; and a motor output setting unit for setting an output set value of a start-up motor of the gas turbine. The motor output setting unit is configured to increase the output set value, during startup of the gas turbine and after a switching timing at which the fuel command value calculated by the fuel command value calculation unit switches from constant to continuous increase.

Furthermore, a gas turbine facility according to at least one embodiment of the present invention includes: a gas turbine including a compressor for compressing air, a combustor for generating a combustion gas by a combustion reaction between fuel and the compressed air from the compressor, and a turbine configured to be driven by the combustion gas from the combustor; and the above-described control device configured to control the operation of the gas turbine.

Furthermore, a control method for a gas turbine according to at least one embodiment of the present invention is a control method for controlling operation of the gas turbine, including: a fuel command value calculation step of calculating a fuel command value to be provided to the gas turbine; and an acceleration rate setting step of setting an acceleration rate set value of a rotor of the gas turbine. The acceleration rate setting step includes increasing the acceleration rate set value, during startup of the gas turbine and after a switching timing at which the fuel command value calculated in the fuel command value calculation step switches from constant to continuous increase.

Furthermore, a control program for a gas turbine according to at least one embodiment of the present invention is a control program for controlling operation of a gas turbine, the control program being configured to cause a computer to execute: a fuel command value calculation process of calculating a fuel command value to be provided to the gas turbine; and an acceleration rate setting process of setting an acceleration rate set value of a rotor of the gas turbine. The acceleration rate setting process includes increasing the acceleration rate set value, during startup of the gas turbine and after a switching timing at which the fuel command value calculated in the fuel command value calculation process switches from constant to continuous increase.

### Advantageous Effects

According to at least one embodiment of the present invention, provided are a control device for a gas turbine, a gas turbine facility, a control method for the gas turbine, and a control program for the gas turbine, which are capable of rapidly starting the gas turbine while suppressing misfire.

### BRIEF DESCRIPTION OF DRAWINGS

FIG. 1 is a schematic configuration diagram of a gas turbine facility including a control device according to an embodiment.

FIG. 2 is a schematic configuration diagram of the control device according to an embodiment.

FIG. 3 is a block diagram showing an arithmetic logic of the control device according to an embodiment.

FIG. 4 is a graph showing an example of a relationship between a rotor rotation speed and an acceleration rate set value at startup of a gas turbine.

FIG. 5 is a graph showing an example of a relationship between the rotor rotation speed and an output set value of a start-up motor at startup of the gas turbine.

FIG. 6 is a graph showing an example of the relationship between the rotor rotation speed and the acceleration rate set value at startup of the gas turbine.

FIG. 7 is a graph showing an example of time variations in the acceleration rate set value, the output set value of the start-up motor, the rotor rotation speed, a fuel command value, an exhaust gas temperature, and an actual acceleration rate of a rotor, at startup of the gas turbine.

### DETAILED DESCRIPTION

Some embodiments of the present invention will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

### Configuration of Gas Turbine Facility

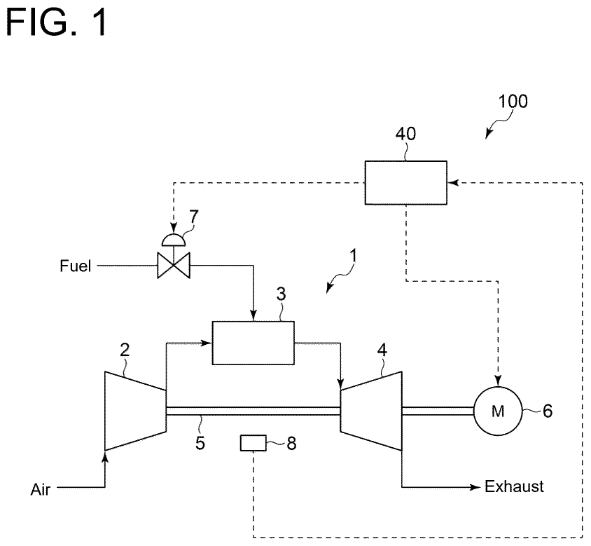

FIG. 1 is a schematic configuration diagram of a gas turbine facility including a control device according to an embodiment. As shown in FIG. 1, a gas turbine facility 100 includes a gas turbine 1 and a control device 40 for controlling operation of the gas turbine 1.

The gas turbine 1 includes a compressor 2 for compressing air, a combustor 3 for burning fuel (for example, natural gas, etc.) to produce a combustion gas, and a turbine 4 configured to rotationally be driven by the combustion gas. The compressor 2 and the turbine 4 are connected via a rotational shaft 5.

The fuel (for example, natural gas, etc.) is supplied to the combustor 3, and the compressed air from the compressor 2 is sent to the combustor 3. The fuel is burned with this compressed air as an oxidizing agent to produce the combustion gas. The flow rate of the fuel supplied to the combustor 3 can be adjusted by a fuel valve 7.

The combustion gas produced in the combustor 3 is introduced to the turbine 4 to rotationally drive the turbine 4. The combustion gas having finished the work in the turbine 4 is discharged from the turbine 4 as an exhaust gas. To the turbine 4, a generator (not shown) may be connected via the rotational shaft 5, so that the generator may be driven by the turbine 4 to generate electric power.

As shown in FIG. 1, the gas turbine 1 may include a start-up motor 6. The start-up motor 6 can apply rotational power to the rotational shaft 5 of the gas turbine 1 to rotationally drive the rotational shaft 5. The start-up motor 6 may be configured to assist rotational drive of the gas turbine 1 until the gas turbine 1 can rotate independently using its own combustion energy, at startup of the gas turbine 1.

In some embodiments, the above-described generator connected to the gas turbine 1 via the rotational shaft 5 may be supplied with electric power and function as the start-up motor 6. In this case, in order to rotate the generator as an electric motor, electric power of variable voltage variable frequency may be supplied to the generator by a frequency converter such as a static frequency converter (SFC).

The gas turbine 1 may include a rotation speed measurement part 8 for measuring a rotation speed of a rotational shaft 5 of the gas turbine 1 (a rotation speed of a rotor of the gas turbine 1). The rotation speed measurement part 8 may include a rotation speed sensor such as an encoder. A signal indicating a measured value of the rotation speed of the rotor by the rotation speed measurement part 8 is sent to the control device 40.

### Configuration of Control Device

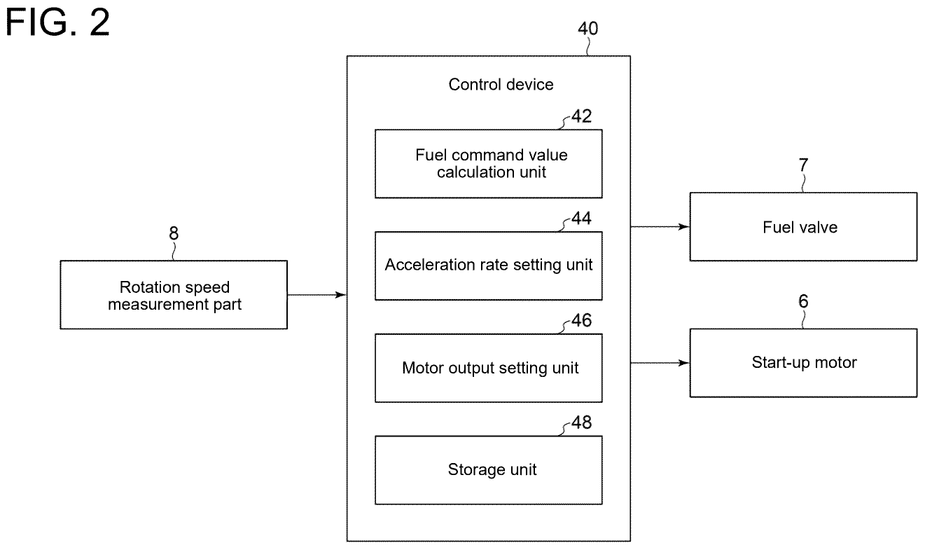

FIG. 2 is a schematic configuration diagram of the control device 40 according to an embodiment. As shown in FIG. 2, the control device 40 includes a fuel command value calculation unit 42 and an acceleration rate setting unit 44. The control device 40 may include a motor output setting unit 46 and/or a storage unit 48. The control device 40 is configured to receive a signal indicating a measured value (actual rotation speed) of the rotation speed of the rotor from the rotation speed measurement part 8, and to process the signal. An arithmetic result in the control device 40 may be sent to the fuel valve 7 or the start-up motor 6, and the fuel valve 7 or the start-up motor 6 may operate on the basis of the arithmetic result.

The fuel command value calculation unit 42 is configured to calculate a fuel command value FI to be provided to the gas turbine 1. On the basis of this fuel command value FI, the opening degree of the fuel valve 7 is adjusted. The control device 40 may be configured to adjust the opening degree of the fuel valve 7 to match the fuel command value FI.

The acceleration rate setting unit 44 is configured to set an acceleration rate set value of the rotor during startup of the gas turbine 1. The acceleration rate setting unit 44 may be configured to set a different acceleration rate set value depending on the rotation speed (a rated rotation speed, etc.) during operation after startup of the gas turbine 1. The acceleration rate set value may be used for arithmetic of the fuel command value FI by the fuel command value calculation unit 42.

The motor output setting unit 46 is configured to set an output set value of the start-up motor 6 during startup of the gas turbine 1. The output set value set by the motor output setting unit 46 is sent to the start-up motor 6, and the start-up motor 6 operates so as to obtain the set output. When the generator is used as the start-up motor 6 together with the frequency converter such as the SFC, the motor output setting unit 46 may be configured to set an output set value of the frequency converter as the output set value of the start-up motor 6.

The storage unit 48 is configured to store input and output to the control device 40, or the arithmetic result, etc., in the control device 40. The acceleration rate setting unit 44 may be configured to read out and set the acceleration rate set value stored in the storage unit 48. The motor output setting unit 46 may be configured to read out and set the output set value stored in the storage unit 48. The storage unit 48 may include a main storage device or an auxiliary storage device of a calculator forming the control device 40.

The control device 40 includes a calculator with a processor (such as CPU), a main storage device (memory device; such as RAM), an auxiliary storage device, an interface, and the like. The control device 40 is configured to receive the signal from the rotation speed measurement part 8 via an interface. The processor is configured to process the signal thus received. In addition, the processor is configured to process programs loaded into the main storage device. Whereby, the function of each of the functional units (the fuel command value calculation unit 42, the acceleration rate setting unit 44, and the motor output setting unit 46) described above is realized.

Processing contents in the control device 40 is implemented as the programs executed by the processor. The programs may be stored in, for example, the auxiliary storage device. When the programs are executed, these programs are loaded into the main storage device. The processor is configured to read out the programs from the main storage device to execute instructions included in the programs.

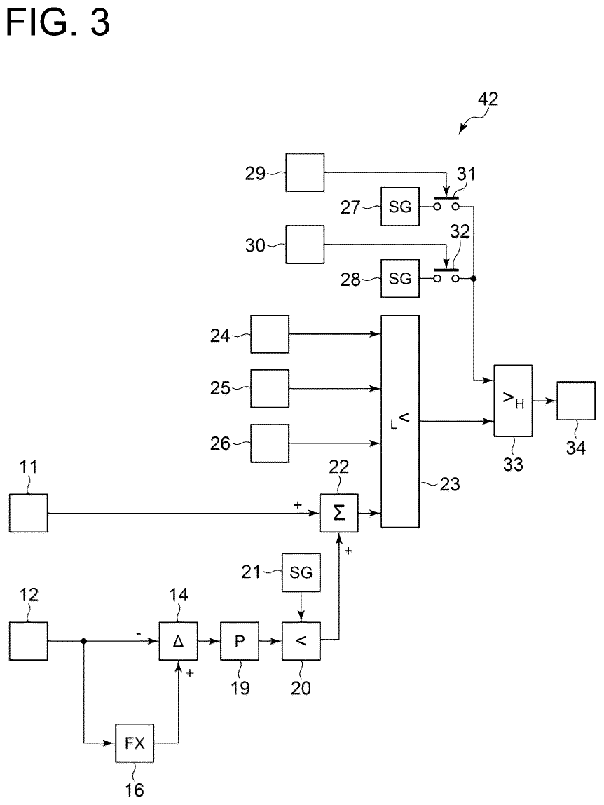

FIG. 3 is a block diagram showing an arithmetic logic of the fuel command value calculation unit 42 of the control device 40 according to an embodiment. The fuel command value calculation unit 42 calculates and outputs the fuel command value FI to be provided to the gas turbine 1.

In FIG. 3, reference sign 11 denotes a surge prevention control output limiter, reference sign 12 denotes a gas turbine rotation speed signal, reference sign 14 denotes a subtractor, reference sign 16 denotes a function generator, reference sign 19 denotes a proportional arithmetic unit, reference sign 20 denotes a low value selector, reference sign 21 denotes a signal generator, reference sign 22 denotes an adder, reference sign 23 denotes a low value selector, reference sign 24 denotes a gas turbine rotation speed control arithmetic output, reference sign 25 denotes a generator output control arithmetic output, reference sign 26 denotes a gas turbine exhaust gas temperature control arithmetic output, reference signs 27 and 28 denote signal generators, reference sign 29 denotes a gas turbine fuel ignition command signal, reference sign 30 denotes a gas turbine misfire prevention command signal, reference signs 31 and 32 denote contact points which close when the respective signals 29 and 30 are on, reference sign 33 denotes a high value selector, and reference sign 34 denotes a gas turbine control arithmetic output (fuel command value output).

In parts of reference signs 11 to 22, the fuel flow rate (second command value F2) is calculated and output on the basis of the rotation speed, etc., of the rotor of the gas turbine 1, as described later. The gas turbine rotation speed control arithmetic output 24 outputs the fuel flow rate in a state where the gas turbine is near the rated rotation speed. The generator output control arithmetic output 25 outputs the fuel flow rate in a state where the generator of the gas turbine 1 is connected to a power system and transmits power thereto. The gas turbine exhaust gas temperature control arithmetic output 26 outputs the fuel flow rate determined on the basis of the exhaust gas temperature of the gas turbine, so that a turbine blade, etc., of the gas turbine does not become abnormally hot. The low value selector 23 selects the lowest value among these outputs and outputs it to the high value selector 33.

At startup of the gas turbine 1, the fuel flow rate (second command value F2) from the parts of reference signs 11 to 22 is the lowest value among the above-described outputs, and is therefore selected by the low value selector 23 and output to the high value selector 33.

Meanwhile, at startup of the gas turbine 1, the output of the signal generator 27 when the gas turbine fuel ignition command signal 29 is on or the output of the signal generator 28 when the gas turbine misfire prevention command signal 30 is on is input to the high value selector 33. The output (first command value F1) of the signal generator 27 or the signal generator 28 is a constant value.

The high value selector 33 selects and outputs the highest value among a plurality of inputs. At startup of the gas turbine 1, the larger of the output (first command value F1) of the signal generator 27 and the fuel flow rate (second command value F2) from the parts of reference signs 11 to 22 is selected and output to the gas turbine control arithmetic output 34. That is, at startup of the gas turbine 1, the larger of the output (first command value F1) of the signal generator 27 and the fuel flow rate (second command value F2) from the parts of reference signs 11 to 22 is calculated as the fuel command value FI.

Herein, arithmetic in the parts of reference signs 11 to 22 will be described. The output of the surge prevention control output limiter 11 is obtained by the rotation speed (rotor rotation speed) of the gas turbine 1 and a discharge pressure of the compressor. The gas turbine rotation speed signal 12 is a signal received from the rotation speed measurement part 8 (a signal indicating the actual rotation speed of the rotor of the gas turbine 1), and is input to the subtractor 14 and the function generator 16.

The function generator 16 receives the actual rotation speed of the rotor from the gas turbine rotation speed signal 12 and also receives the acceleration rate set value from the acceleration rate setting unit 44 (see FIG. 2), and calculates a target rotation speed of the rotor of the gas turbine 1 on the basis of the actual rotation speed of the rotor and the acceleration rate set value. The function generator 16 may calculate the target rotation speed by adding an increase in rotation speed according to the acceleration rate to the actual rotation speed of the rotor.

The subtractor 14 subtracts the gas turbine rotation speed signal 12 from the output of the function generator 16, and inputs the result to the proportional arithmetic unit 19. The proportional arithmetic unit 19 multiplies this by an internally set coefficient and outputs the result. The low value selector 20 outputs a value of the lower of the output of the proportional arithmetic unit 19 and the output of the signal generator 21. The output of the signal generator 21 is normally zero, and thus the output of the low value selector 20 is always a negative value. The adder 22 outputs a value obtained by adding the output of the surge prevention control output limiter 11 and the output of the low value selector 20. In the parts of reference signs 11 to 22, the output (second command value) related to the fuel flow rate is thus calculated on the basis of the rotation speed, etc., of the gas turbine 1.

### Control Flow of Gas Turbine

Next, a control method for the gas turbine 1 according to some embodiments will be described. Hereinafter, a case will be described in which the above-described gas turbine 1 is controlled by using the above-described control device 40. However, in some embodiments, the control method for the gas turbine may be performed by using another device, or part or all of processes described below may be performed manually.

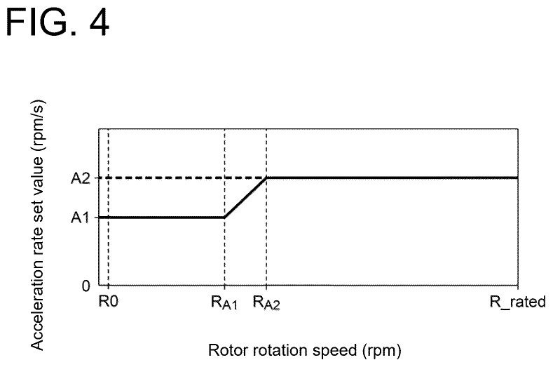

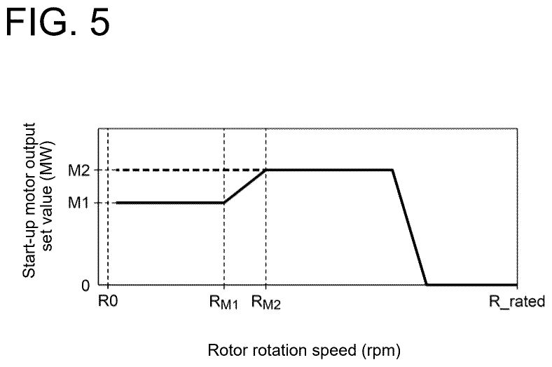

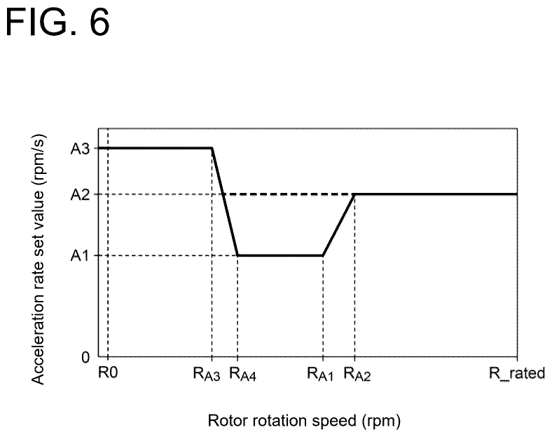

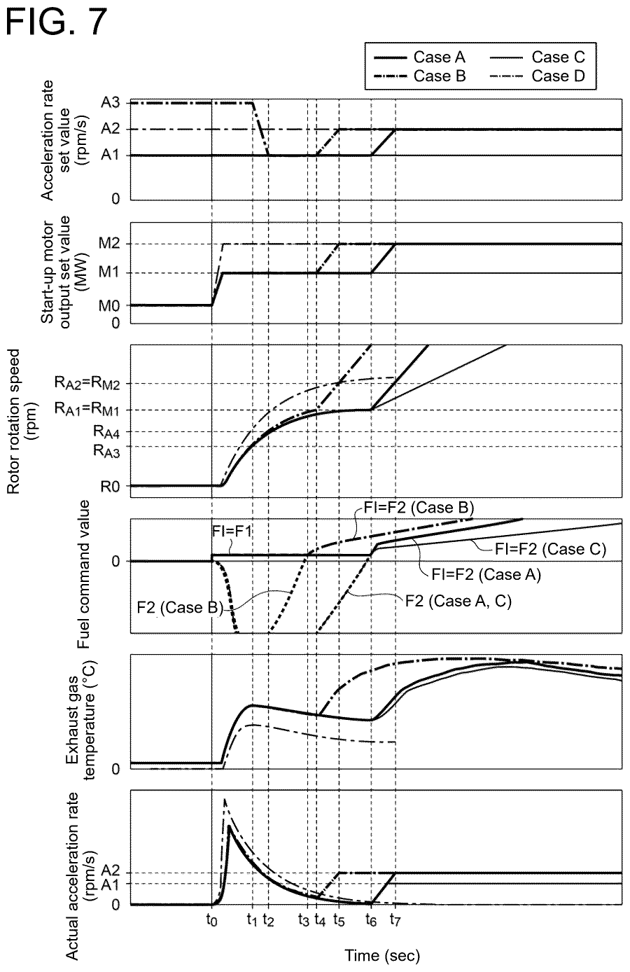

FIGS. 4 and 6 are each a graph showing an example of a relationship between the rotor rotation speed and the acceleration rate set value at startup of the gas turbine. FIG. 5 is a graph showing an example of a relationship between the rotor rotation speed and the output set value of the start-up motor at startup of the gas turbine. FIG. 7 is a graph showing an example of time variations in the acceleration rate set value, the output set value of the start-up motor, the rotation speed (actual rotation speed) of the rotor, the fuel command value, the exhaust gas temperature, and an actual acceleration rate of the rotor, at startup of the gas turbine, in a plurality of cases (cases A to D).

In FIGS. 4 to 7, R0 is a rotor speed of the rotor at the time of ignition of the gas turbine 1 (time point of t0 in FIG. 7), and R_rated is a rotation speed (for example, a rated rotation speed) during operation after startup of the gas turbine 1. Startup of the gas turbine 1 includes a period from when the rotor of the gas turbine 1 starts to rotate until the rotor rotation speed increases to a predetermined rotation speed (for example, the rated rotation speed).

First, the control flow in case C which is a conventional typical example will be described with reference to FIG. 7.

In case C, in a period prior to the time t0, the rotor of the gas turbine 1 is rotationally driven by the start-up motor 6. At this time, an output set value of the start-up motor 6 is set to M0.

At the time t0, the fuel is ignited in the combustor 3. A rotor rotation speed at this time is R0. At the time to, the acceleration rate set value and the output set value of the start-up motor 6 are set to predetermined values (for example, values determined in advance according to the rotation speed, etc., after startup of the gas turbine 1). In case C, an acceleration rate set value is set to A1, and an output set value of the start-up motor 6 is set to M1, respectively.

After the time to, the fuel command value FI calculated by the fuel command value calculation unit 42 is constant. That is, the fuel command value calculation unit 42 calculates, as the fuel command value FI, the first command value F1 which is the larger of the above-described first command value F1 (constant value) and the second command value F2 calculated from the rotation speed, etc., of the rotor. The fuel is supplied to the gas turbine 1 on the basis of this fuel command value FI, and the rotor rotation speed increases to a certain extent as shown in the graph.

At time t6, the fuel command value switches from constant to continuous increase. That is, the fuel command value FI calculated by the fuel command value calculation unit 42 is switched from the first command value F1 which is the constant value to the second command value F2 calculated on the basis of the rotor rotation speed, etc. A time point at which the fuel command value switches from constant to continuous increase is called a switching timing.

Even after the time t6, the acceleration rate set value is maintained at A1, and the output set value of the start-up motor 6 is maintained at M1. After the time t6, the rotor rotation speed increases with a substantially constant gradient. This gradient corresponds to the acceleration rate set value A1. The rotor rotation speed is increased until the rotor rotation speed reaches the predetermined rotation speed (for example, the rated rotation speed).

Next, the control flow of case A according to an embodiment will be described. The control flow in case A is the same as that in case C up to the switching timing (time point of t6 in cases A and C) at which the fuel command value switches from constant to continuous increase. However, in case A, after the switching timing, the acceleration rate setting unit 44 increases the acceleration rate set value from A1 (first acceleration rate) to A2 (second acceleration rate). In the example shown in the graph of FIG. 7, the acceleration rate set value is increased from A1 to A2 between the time t6 (the time point of the switching timing) and time t7, and the acceleration rate set value is maintained at A2 after the time t7.

The acceleration rate setting unit 44 may determine the acceleration rate set value on the basis of the rotor rotation speed. That is, as shown in FIG. 4, the acceleration rate set value may be set to A1 until the rotor rotation speed reaches R_{A1}, and once the rotor rotation speed reaches R_{A1}, the acceleration rate set value may be increased from A1 to A2. Herein, R_{A1} is a rotation speed not less than the rotation speed at which the switch timing occurs. In the example shown in FIG. 4, the acceleration rate set value is increased from A1 to A2 while the rotor rotation speed changes from R_{A1} to R_{A2}.

In case A described above, the acceleration rate set value set after the switching timing is A2 and is greater than A1 in case C. Thus, in case A, the gradient of increase in rotor rotation speed after the switching timing is greater than in case C. Therefore, a time required for the rotation speed of the rotor to increase to the predetermined rotation speed is shortened, and a startup time of the gas turbine 1 is shortened.

Also, in order to shorten the startup time of the gas turbine 1, as shown in case D, the acceleration rate set value could be set to the relatively large value (A2) from the time of ignition (time t0). However, as in case D, if the acceleration rate set value is uniformly set to the large value (A2), the rotor rotation speed increases rapidly, and the fuel-air ratio (F/A ratio) decreases due to an increase in amount of air suction in the compressor 2, increasing the possibility of misfire occurring in the combustor 3. The graph of FIG. 7 shows the fact that after ignition at the time to, the amount of rise of the exhaust gas temperature in case D remains low and decreases is attributed to the decrease in fuel-air ratio (F/A ratio) due to the large increase in rotation speed.

In contrast, in case A described above, since the acceleration rate set value is set to the relatively low value (A1) before the switching timing and the acceleration rate set value is increased after the switching timing at which the fuel command value starts to increase continuously, it is possible to suppress misfire by suppressing the decrease in fuel-air ratio (F/A ratio).

Therefore, in case A described above, the gas turbine can be started rapidly while suppressing misfire.

Further, in the compressor 2, if the rotor rotation speed is held in a predetermined rotation speed range, a rotating stall may occur and the blade may be damaged. In this regard, in case A described above, since the acceleration rate set value after the switching timing at which the fuel command value switches from constant to continuous increase is increased relatively, it is possible to quickly pass through the rotation speed range in which rotating stall occurs in the compressor 2. Therefore, the gas turbine can be started rapidly while suppressing rotating stall occurs in the compressor.

In some embodiments, for example as in case A described above, the first acceleration rate A1 is set as the acceleration rate set value at a time point prior to the switching timing, and the acceleration rate set value is increased to the second acceleration rate A2 after the switching timing. In some embodiments, a ratio r_{A} of the second acceleration rate A2 to the first acceleration rate (r_{A}=A2/A1) may be at least 1.2 or at most 1.5.

After the switching timing, by thus increasing the acceleration rate set value of the rotor from the value (first acceleration rate A1) before the switching timing to the second acceleration rate A2, it is possible to start the gas turbine 1 in a relatively short time while more effectively suppressing misfire due to the decrease in fuel-air ratio.

In case A in FIG. 7, after the switching timing, the motor output setting unit 46 increases the output set value of the start-up motor 6 from M1 (first output) to M2 (second output). In the example shown in the graph of FIG. 7, the output set value is increased from M1 to M2 between the time t6 (the time point of the switching timing) and the time t7, and the output set value is maintained at M2 after the time t7.

The motor output setting unit 46 may determine the output set value on the basis of the rotor rotation speed. That is, as shown in FIG. 5, the output set value may be set to M1 until the rotor rotation speed reaches R_{M1}, and once the rotor rotation speed reaches R_{M1}, the output set value may be increased from M1 to M2. Herein, R_{M1} is a rotation speed not less than the rotation speed at which the switch timing occurs. In the example shown in FIG. 5, the output set value is increased from M1 to M2 while the rotor rotation speed changes from R_{M1} to R_{M2}.

In case A described above, the output set value of the start-up motor 6 is increased during startup of the gas turbine 1 and after the switching timing at which the fuel command value switches from constant to continuous increase. After the switching timing, by thus increasing the output set value of the start-up motor along with the acceleration rate set value, the rotor can be accelerated while suppressing the increase in fuel command value. Whereby, it is possible to suppress a temperature rise of the combustion gas introduced from the combustor 3 to the turbine 4 (that is, the rise of the exhaust gas temperature, which is shown in FIG. 7, is also suppressed). Therefore, the gas turbine 1 can be started rapidly while suppressing misfire, while suppressing damage to the turbine component, which is caused by the high-temperature combustion gas.

In some embodiments, for example as in case A described above, the first output M1 is set as the output set value of the start-up motor 6 at the time point prior to the switching timing, and the output set value is increased to the second output M2 after the switching timing. In some embodiments, a ratio r_{B} of the second output M2 to the first output (r_{B}=M2/M1) may be at least 1.2 or at most 1.5.

After the switching timing, by thus increasing the output set value of the start-up motor 6 from the value (first output M1) before the switching timing to the second output M2, it is possible to effectively suppress the temperature rise of the combustion gas introduced from the combustor 3 to the turbine 4. Therefore, the gas turbine 1 can be started rapidly while suppressing misfire, while effectively suppressing the damage to the turbine component, which is caused by the high-temperature combustion gas.

In some embodiments, a ratio r_{A}/r_{B} of the ratio r_{A} of the second acceleration rate A2 to the first acceleration rate A1 to the ratio r_{B} of the second output M2 to the first output M1, which are described above, is at least 0.8 and at most 1.2.

In the above-described embodiment, the acceleration rate set value and the output set value of the start-up motor are increased by the same amount, during startup of the gas turbine 1 and after the switching timing at which the fuel command value switches from constant to continuous increase. Therefore, the gas turbine 1 can be started rapidly while effectively suppressing the misfire due to the decrease in fuel-air ratio and the damage to the turbine component due to the temperature rise of the combustion gas.

In some embodiments, the acceleration rate setting unit 44 and the motor output setting unit 46 are configured to simultaneously increase the acceleration rate set value and the output set value, after the switching timing. For example, in case A in FIG. 7, the acceleration rate set value and the output set value are increased simultaneously between the times t6 and t7.

In the above-described embodiment, the acceleration rate set value and the output set value of the start-up motor are increased simultaneously, during startup of the gas turbine 1 and after the switching timing at which the fuel command value switches from constant to continuous increase. Therefore, the gas turbine 1 can be started rapidly while effectively suppressing the misfire due to the decrease in fuel-air ratio and the damage to the turbine component due to the temperature rise of the combustion gas.

In some embodiments, the acceleration rate setting unit 44 is configured to start increasing the acceleration rate set value by the time the rotation speed of the rotor increases by 300 rpm from the time point of the switch timing. In case A in FIG. 7, the acceleration rate set value starts to increase at the same time as the switching timing (time point of t6).

In the above-described embodiment, since the acceleration rate set value starts to increase within the short period of time from the time point of the switching timing at which the fuel command value switches from constant to continuous increase until the rotation speed of the rotor increases by 300 rpm, during startup of the gas turbine 1 and after the switching timing, it is possible to start the gas turbine more rapidly while suppressing misfire.

In some embodiments, the motor output setting unit 46 is configured to start increasing the output set value of the start-up motor 6 by the time the rotation speed of the rotor increases by 300 rpm from the time point of the switch timing. In case A in FIG. 7, the output set value starts to increase at the same time as the switching timing (time point of t6).

In the above-described embodiment, since the output set value of the start-up motor 6 starts to increase within the short period of time from the time point of the switching timing at which the fuel command value switches from constant to continuous increase until the rotation speed of the rotor increases by 300 rpm, during startup of the gas turbine 1 and after the switching timing, it is possible to start the gas turbine more rapidly while suppressing the damage to the turbine component due to the temperature rise of the combustion gas.

Next, the control flow of case B according to an embodiment will be described. The control flow in case B is the same as that in case A in that the acceleration rate set value increases from A1 (first acceleration rate) to A2 (second acceleration rate) after the switching timing at which the fuel command value switches from constant to continuous increase (the time point of t6 in case A, the time point of t3 in case B).

In case B, during startup of the gas turbine 1, the first acceleration rate A1 is set as the acceleration rate set value at a time point prior to the switching timing (time t3), and at a time point prior to the above-described time point, a third acceleration rate A3 greater than the first acceleration rate A1 is set as the acceleration rate set value. In the example shown in the graph of FIG. 7, after the time point (time t0) of the ignition of the gas turbine 1, the acceleration rate set value is maintained at A3 until the time t1, and the acceleration rate set value is decreased from A3 to A1 between the times t1 and t2. Thereafter, between times t4 and t5 after the switching timing (time t3) has elapsed, the acceleration rate set value increases from A1 to A2.

The acceleration rate setting unit 44 may determine the acceleration rate set value on the basis of the rotor rotation speed. That is, as shown in FIG. 6, the acceleration rate set value may be set to A3 until the rotor rotation speed increases from R0 to R_{A3}, and once the rotor rotation speed reaches R_{A3}, the acceleration rate set value may be decreased from A3 to A1. In the example shown in FIG. 6, the acceleration rate set value is decreased from A3 to A1 while the rotor rotation speed changes from R_{A3} to R_{A4}. Further, the acceleration rate set value may be maintained at A1 until the rotor rotation speed increases from R_{A4} to R_{A1}, and once the rotor rotation speed reaches R_{A1}, the acceleration rate set value may be increased from A1 to A2. In the example shown in FIG. 6, the acceleration rate set value is increased from A1 to A2 while the rotor rotation speed changes from R_{A1} to RA₂.

In Case B, during startup of the gas turbine 1, the third acceleration rate A3 greater than the first acceleration rate A1 is set as the acceleration rate set value at a second time point (t0 to t1) prior to a first time point (times t2 to t3) at which the relatively low first acceleration rate A1 is set as the acceleration rate set value prior to the switching timing (time t3). Therefore, compared to case A, etc., in which the third acceleration rate A3 is not set, the second command value F2 based on a deviation between an actual rotation speed and a target rotation speed of the rotor becomes a larger value. Consequently, it is possible to advance the switching timing at which the second command value F2 becomes greater than the first command value F1, whereby the gas turbine can be started more rapidly.

The above-described third acceleration rate A3 may be greater than the second acceleration rate A2 set after the switching timing. Whereby, since the second command value F2 based on the deviation between the actual rotation speed and the target rotation speed of the rotor becomes the larger value, it is possible to further advance the switching timing at which the second command value F2 becomes greater than the first command value F1. Thus, the gas turbine can be started more rapidly.

The contents described in the above embodiments would be understood as follows, for instance.
(1) A control device (40) for a gas turbine according to at least one embodiment of the present invention is a control device for controlling operation of the gas turbine (1), including: a fuel command value calculation unit (42) for calculating a fuel command value to be provided to the gas turbine; and an acceleration rate setting unit (44) for setting an acceleration rate set value of a rotor of the gas turbine. The acceleration rate setting unit is configured to increase the acceleration rate set value, during startup of the gas turbine and after a switching timing at which the fuel command value calculated by the fuel command value calculation unit switches from constant to continuous increase.

According to the above configuration (1), the acceleration rate set value of the rotor is increased during startup of the gas turbine and after the switching timing at which the fuel command value switches from constant to continuous increase. As described above, since the acceleration rate set value is set to the relatively low value before the switching timing and the acceleration rate set value is increased after the switching timing at which the fuel command value starts to increase continuously, it is possible to start the gas turbine in a relatively short time while suppressing misfire by suppressing the decrease in fuel-air ratio (F/A ratio). That is, the gas turbine can be started rapidly while suppressing misfire.
(2) In some embodiments, in the above configuration (1), the acceleration rate setting unit is configured to set a first acceleration rate (A1) as the acceleration rate set value at a time point prior to the switching timing and is configured to increase the acceleration rate set value to a second acceleration rate (A2) greater than the first acceleration rate after the switching timing.

According to the above configuration (2), after the switching timing, since the acceleration rate set value of the rotor is increased from the value (first acceleration rate) before the switching timing to the second acceleration rate, it is possible to start the gas turbine in a relatively short time while more effectively suppressing the misfire due to the decrease in fuel-air ratio.
(3) In some embodiments, in the above configuration (1) or (2), the control device for the gas turbine includes a motor output setting unit (46) for setting an output set value of a start-up motor of the gas turbine. The motor output setting unit is configured to increase the output set value, after the switching timing.

According to the above configuration (3), the output set value of the start-up motor is increased during startup of the gas turbine and after the switching timing at which the fuel command value switches from constant to continuous increase. After the switching timing, by thus increasing the output set value of the start-up motor along with the acceleration rate set value, the rotor can be accelerated while suppressing the increase in fuel command value. Whereby, it is possible to suppress the temperature rise of the combustion gas introduced from the combustor to the turbine. Therefore, the gas turbine can be started rapidly while suppressing misfire, while suppressing damage to the turbine component, which is caused by the high-temperature combustion gas.
(4) In some embodiments, in the above configuration (3), the motor output setting unit is configured to set a first output (M1) as the output set value at a time point prior to the switching timing and is configured to increase the output set value to a second output (M2) greater than the first output after the switching timing.

According to the above configuration (4), after the switching timing, since the output set value of the start-up motor is increased from the value (first output) before the switching timing to the second output, it is possible to effectively suppress the temperature rise of the combustion gas introduced from the combustor to the turbine. Therefore, the gas turbine can be started rapidly while suppressing misfire, while effectively suppressing the damage to the turbine component, which is caused by the high-temperature combustion gas.
(5) In some embodiments, in the above configuration (3) or (4), the acceleration rate setting unit is configured to set a first acceleration rate as the acceleration rate set value at a time point prior to the switching timing and is configured to increase the acceleration rate set value to a second acceleration rate greater than the first acceleration rate after the switching timing, the motor output setting unit is configured to set a first output as the output set value at a time point prior to the switching timing and is configured to increase the output set value to a second output greater than the first output after the switching timing, and a ratio r_{A}/r_{B} of a ratio r_{A} of the second acceleration rate to the first acceleration rate to a ratio r_{B} of the second output to the first output is at least 0.8 and at most 1.2.

According to the above configuration (5), the acceleration rate set value and the output set value of the start-up motor are increased by the same amount during startup of the gas turbine and after the switching timing at which the fuel command value switches from constant to continuous increase. Therefore, the gas turbine can be started rapidly while effectively suppressing the misfire due to the decrease in fuel-air ratio and the damage to the turbine component due to the temperature rise of the combustion gas.
(6) In some embodiments, in any of the above configurations (3) to (5), the acceleration rate setting unit and the motor output setting unit are configured to simultaneously increase the acceleration rate set value and the output set value, after the switching timing.

According to the above configuration (6), the acceleration rate set value and the output set value of the start-up motor are increased simultaneously during startup of the gas turbine and after the switching timing at which the fuel command value switches from constant to continuous increase. Therefore, the gas turbine can be started rapidly while effectively suppressing the misfire due to the decrease in fuel-air ratio and the damage to the turbine component due to the temperature rise of the combustion gas.
(7) In some embodiments, in any of the above configurations (1) to (6), the acceleration rate setting unit is configured to start increasing the acceleration rate set value by a time a rotation speed of the rotor increases by 300 rpm from a time point of the switch timing.

According to the above configuration (7), since the acceleration rate set value starts to increase within the short period of time from the time point of the switching timing at which the fuel command value switches from constant to continuous increase until the rotation speed of the rotor increases by 300 rpm, during startup of the gas turbine and after the switching timing, it is possible to start the gas turbine more rapidly while suppressing misfire.
(8) In some embodiments, in any of the above configurations (1) to (7), the fuel command value calculation unit is configured to calculate, as the fuel command value, a larger one of a first command value which is a constant value and a second command value which is calculated on the basis of a deviation between an actual rotation speed and a target rotation speed of the rotor, during startup of the gas turbine, and the switching timing is a timing at which the fuel command value calculated by the fuel command value calculation unit switches from the first command value to the second command value.

According to the above configuration (8), the acceleration rate set value is increased during startup of the gas turbine and after the switching timing at which the fuel command value switches from the first command value which is the constant value to the second command value based on the deviation between the actual rotation speed and the target rotation speed of the rotor. As described above, since the acceleration rate set value is set to the relatively low value before the switching timing and the acceleration rate set value is increased after the switching timing at which the fuel command value starts to increase continuously, it is possible to start the gas turbine in a relatively short time while suppressing misfire by suppressing the decrease in fuel-air ratio (F/A ratio). That is, the gas turbine can be started rapidly while suppressing misfire.
(9) In some embodiments, in the above configuration (8), the fuel command value calculation unit is configured to calculate the target rotation speed of the rotor on the basis of the actual rotation speed of the rotor and the acceleration rate set value.

According to the above configuration (9), since the target rotation speed of the rotor is calculated on the basis of the actual rotation speed of the rotor and the acceleration rate set value, the second command value of the fuel command value corresponds to the acceleration rate set value of the rotor. Thus, the second command value can be calculated appropriately according to the acceleration rate set value.
(10) In some embodiments, in the above configuration (8) or (9), the acceleration rate setting unit is configured to set a first acceleration rate (A1) as the acceleration rate set value at a first time point prior to the switching timing and is configured to set a third acceleration rate (A3) greater than the first acceleration rate as the acceleration rate set value at a second time point prior to the first time point, during startup of the gas turbine.

According to the above configuration (10), during startup of the gas turbine, the third acceleration rate greater than the first acceleration rate is set as the acceleration rate set value at the second time point prior to the first time point at which the relatively low first acceleration rate is set as the acceleration rate set value before the switching timing. Consequently, it is possible to advance the switching timing at which the second command value based on the deviation between the actual rotation speed and the target rotation speed of the rotor becomes greater than the first command value, whereby the gas turbine can be started more rapidly.
(11) A control device (40) for a gas turbine according to at least one embodiment of the present invention is a control device for controlling operation of a gas turbine, including: a fuel command value calculation unit (42) for calculating a fuel command value to be provided to the gas turbine; and a motor output setting unit (46) for setting an output set value of a start-up motor of the gas turbine. The motor output setting unit is configured to increase the output set value, during startup of the gas turbine and after a switching timing at which the fuel command value calculated by the fuel command value calculation unit switches from constant to continuous increase.

According to the above configuration (11), the output set value of the start-up motor is increased during startup of the gas turbine and after the switching timing at which the fuel command value switches from constant to continuous increase. After the switching timing, by thus increasing the output set value of the start-up motor, the rotor can be accelerated while suppressing the increase in fuel command value. Whereby, it is possible to suppress the temperature rise of the combustion gas introduced from the combustor to the turbine. Therefore, it is possible to suppress the damage to the turbine component, which is caused by the high-temperature combustion gas.
(12) A gas turbine facility (100) according to at least one embodiment of the present invention, includes: a gas turbine (1) including a compressor (2) for compressing air, a combustor (3) for generating a combustion gas by a combustion reaction between fuel and the compressed air from the compressor, and a turbine (4) configured to be driven by the combustion gas from the combustor; and the control device (40) according to any one of the above (1) to (11) configured to control the operation of the gas turbine.

According to the above configuration (12), the acceleration rate set value of the rotor is increased during startup of the gas turbine and after the switching timing at which the fuel command value switches from constant to continuous increase. As described above, since the acceleration rate set value is set to the relatively low value before the switching timing and the acceleration rate set value is increased after the switching timing at which the fuel command value starts to increase continuously, it is possible to start the gas turbine in a relatively short time while suppressing misfire by suppressing the decrease in fuel-air ratio (F/A ratio). That is, the gas turbine can be started rapidly while suppressing misfire.
(13) A control method for a gas turbine according to at least one embodiment of the present invention is a control method for controlling operation of a gas turbine, including: a fuel command value calculation step of calculating a fuel command value to be provided to the gas turbine; and an acceleration rate setting step of setting an acceleration rate set value of a rotor of the gas turbine. The acceleration rate setting step includes increasing the acceleration rate set value, during startup of the gas turbine and after a switching timing at which the fuel command value calculated in the fuel command value calculation step switches from constant to continuous increase.

According to the above method (13), the acceleration rate set value of the rotor is increased during startup of the gas turbine and after the switching timing at which the fuel command value switches from constant to continuous increase. As described above, since the acceleration rate set value is set to the relatively low value before the switching timing and the acceleration rate set value is increased after the switching timing at which the fuel command value starts to increase continuously, it is possible to start the gas turbine in a relatively short time while suppressing misfire by suppressing the decrease in fuel-air ratio (F/A ratio). That is, the gas turbine can be started rapidly while suppressing misfire.
(14) A control program for a gas turbine according to at least one embodiment of the present invention is a control program for controlling operation of a gas turbine, the control program being configured to cause a computer to execute: a fuel command value calculation process of calculating a fuel command value to be provided to the gas turbine; and an acceleration rate setting process of setting an acceleration rate set value of a rotor of the gas turbine. The acceleration rate setting process includes increasing the acceleration rate set value, during startup of the gas turbine and after a switching timing at which the fuel command value calculated in the fuel command value calculation process switches from constant to continuous increase.

According to the above configuration (14), the acceleration rate set value of the rotor is increased during startup of the gas turbine and after the switching timing at which the fuel command value switches from constant to continuous increase. As described above, since the acceleration rate set value is set to the relatively low value before the switching timing and the acceleration rate set value is increased after the switching timing at which the fuel command value starts to increase continuously, it is possible to start the gas turbine in a relatively short time while suppressing misfire by suppressing the decrease in fuel-air ratio (F/A ratio). That is, the gas turbine can be started rapidly while suppressing misfire.

Embodiments of the present invention were described in detail above, but the present invention is not limited thereto, and also includes an embodiment obtained by modifying the above-described embodiments and an embodiment obtained by combining these embodiments as appropriate.

Further, in the present specification, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, an expression of a shape such as a rectangular shape or a cylindrical shape shall not be construed as only the geometrically strict shape, but also includes a shape with unevenness or chamfered corners within the range in which the same effect can be achieved. Furthermore, in the present specification, the expressions “comprising”, “including” or “having” one constitutional element is not an exclusive expression that excludes the presence of other constitutional elements.

### REFERENCE SIGNS LIST

1 Gas turbine
2 Compressor
3 Combustor
4 Turbine
5 Rotational shaft
6 Start-up motor
7 Fuel valve
8 Rotation speed measurement part
11 Surge prevention control output limiter
12 Gas turbine rotation speed signal
14 Subtractor
16 Function generator
19 Proportional arithmetic unit
20 Low value selector
21 Signal generator
22 Adder
23 Low value selector
24 Gas turbine rotation speed control arithmetic output
25 Generator output control arithmetic output
26 Gas turbine exhaust gas temperature control arithmetic output
27 Signal generator
28 Signal generator
29 Gas turbine fuel ignition command signal
30 Gas turbine misfire prevention command signal
33 High value selector
34 Gas turbine control arithmetic output
40 Control device
42 Fuel command value calculation unit
44 Acceleration setting unit
46 Motor output setting unit
48 Storage unit
100 Gas turbine facility

1. A control device for controlling operation of a gas turbine, comprising:
a fuel command value calculation unit for calculating a fuel command value to be provided to the gas turbine; and
an acceleration rate setting unit for setting an acceleration rate set value of a rotor of the gas turbine,
wherein the acceleration rate setting unit is configured to increase the acceleration rate set value, during startup of the gas turbine and after a switching timing at which the fuel command value calculated by the fuel command value calculation unit switches from constant to continuous increase.

2. The control device for the gas turbine according to claim 1,
wherein the acceleration rate setting unit is configured to set a first acceleration rate as the acceleration rate set value at a time point prior to the switching timing and is configured to increase the acceleration rate set value to a second acceleration rate greater than the first acceleration rate after the switching timing.

3. The control device for the gas turbine according to claim 1, comprising:
a motor output setting unit for setting an output set value of a start-up motor of the gas turbine,
wherein the motor output setting unit is configured to increase the output set value, after the switching timing.

4. The control device for the gas turbine according to claim 3,
wherein the motor output setting unit is configured to set a first output as the output set value at a time point prior to the switching timing and is configured to increase the output set value to a second output greater than the first output after the switching timing.

5. The control device for the gas turbine according to claim 3,
wherein the acceleration rate setting unit is configured to set a first acceleration rate as the acceleration rate set value at a time point prior to the switching timing and is configured to increase the acceleration rate set value to a second acceleration rate greater than the first acceleration rate after the switching timing,
wherein the motor output setting unit is configured to set a first output as the output set value at a time point prior to the switching timing and is configured to increase the output set value to a second output greater than the first output after the switching timing, and
wherein a ratio r_{A}/r_{B} of a ratio r_{A} of the second acceleration rate to the first acceleration rate to a ratio r_{B} of the second output to the first output is at least 0.8 and at most 1.2.

6. The control device for the gas turbine according to claim 3,
wherein the acceleration rate setting unit and the motor output setting unit are configured to simultaneously increase the acceleration rate set value and the output set value, after the switching timing.

7. The control device for the gas turbine according to claim 1,
wherein the acceleration rate setting unit is configured to start increasing the acceleration rate set value by a time a rotation speed of the rotor increases by 300 rpm from a time point of the switch timing.

8. The control device for the gas turbine according to claim 1,
wherein the fuel command value calculation unit is configured to calculate, as the fuel command value, a larger one of a first command value which is a constant value and a second command value which is calculated on the basis of a deviation between an actual rotation speed and a target rotation speed of the rotor, during startup of the gas turbine, and
wherein the switching timing is a timing at which the fuel command value calculated by the fuel command value calculation unit switches from the first command value to the second command value.

9. The control device for the gas turbine according to claim 8,
wherein the fuel command value calculation unit is configured to calculate the target rotation speed of the rotor on the basis of the actual rotation speed of the rotor and the acceleration rate set value.

10. The control device for the gas turbine according to claim 8,
wherein the acceleration rate setting unit is configured to set a first acceleration rate as the acceleration rate set value at a first time point prior to the switching timing and is configured to set a third acceleration rate greater than the first acceleration rate as the acceleration rate set value at a second time point prior to the first time point, during startup of the gas turbine.

11. A control device for controlling operation of a gas turbine, comprising:
a fuel command value calculation unit for calculating a fuel command value to be provided to the gas turbine; and
a motor output setting unit for setting an output set value of a start-up motor of the gas turbine,
wherein the motor output setting unit is configured to increase the output set value, during startup of the gas turbine and after a switching timing at which the fuel command value calculated by the fuel command value calculation unit switches from constant to continuous increase.

12. A gas turbine facility, comprising:
a gas turbine including a compressor for compressing air, a combustor for generating a combustion gas by a combustion reaction between fuel and the compressed air from the compressor, and a turbine configured to be driven by the combustion gas from the combustor; and
the control device according to claim 1, configured to control the operation of the gas turbine.

13. A control method for controlling operation of a gas turbine, comprising:
a fuel command value calculation step of calculating a fuel command value to be provided to the gas turbine; and
an acceleration rate setting step of setting an acceleration rate set value of a rotor of the gas turbine,
wherein the acceleration rate setting step includes increasing the acceleration rate set value, during startup of the gas turbine and after a switching timing at which the fuel command value calculated in the fuel command value calculation step switches from constant to continuous increase.

14. A control program for controlling operation of a gas turbine,
the control program being configured to cause a computer to execute:
a fuel command value calculation process of calculating a fuel command value to be provided to the gas turbine; and
an acceleration rate setting process of setting an acceleration rate set value of a rotor of the gas turbine,
wherein the acceleration rate setting process includes increasing the acceleration rate set value, during startup of the gas turbine and after a switching timing at which the fuel command value calculated in the fuel command value calculation process switches from constant to continuous increase.
